(19) United States
(12) Patent Application Publication
(10) Pub. No.: US 2025/0279866 A1
(43) Pub. Date: Sep. 4, 2025

(54) METHOD, DEVICE AND COMPUTER READABLE MEDIUM FOR COMMUNICATIONS

(71) Applicant: NEC Corporation, Tokyo (JP)

(72) Inventors: Zhaobang MIAO, Beijing (CN); Ying ZHAO, Beijing (CN); Gang WANG, Beijing (CN)

(73) Assignee: NEC Corporation, Tokyo (JP)

(21) Appl. No.: 18/857,529

(22) PCT Filed: Apr. 18, 2022
(86) PCT No.: PCT/CN2022/087430

§ 371 Date: Oct. 17, 2024

(51) Int. Cl. H04L 5/00; H04W 16/14; H04W 72/21; H04W 72/232

(52) U.S. Cl. CPC H04L 5/0053; H04W 16/14; H04W 72/21; H04W 72/232

(57) ABSTRACT

Embodiments of the present disclosure relate to method, device and computer readable media for communications. A method for communications comprises: in response to a failure of sidelink transmission in any of a set of resources provided by a network device due to a channel access failure for each of the resources, generating, at a terminal device, a negative acknowledge; and transmitting the negative acknowledge to the network device in a Physical Uplink Control Channel (PUCCH) resource subsequent to the set of resources.

### TECHNICAL FIELD

Embodiments of the present disclosure generally relate to the field of telecommunication, and in particular, to a method, device and computer readable media for sidelink communications.

### BACKGROUND

Sidelink in unlicensed spectrum or band (SL-U) is to be studied in Release 18 sidelink evolution work item of the 3rd Generation Partnership Project (3GPP). The scheme of SL-U should be based on New Radio (NR) sidelink and NR-U.

In sidelink communications, there are two modes of resource allocation. In a first mode (also referred to as NR sidelink mode 1 or mode 1 hereinafter), one terminal device may perform sidelink communications with the other terminal device by using resources allocated by a network device. In a second mode (also referred to as NR sidelink mode 2 or mode 2 hereinafter), one terminal device may perform sidelink communications with the other terminal device by using resources autonomously selected in a resource pool by the one terminal device.

### SUMMARY

In general, example embodiments of the present disclosure provide methods, devices and computer readable media for communications.

In a first aspect, there is provided a method for communications. The method comprises: determining, at a first terminal device, a Channel Occupancy Time (COT) duration, a first Reference Signal Receiving Power (RSRP) threshold and a second RSRP threshold associated with the COT duration; and determining a first set of candidate resources by excluding a candidate resource from an initial set of candidate resources based on the COT duration and one of the first RSRP threshold and the second RSRP threshold.

In a second aspect, there is provided a method for communications. The method comprises: selecting, at a first terminal device, at least one resource for sidelink transmission, from a first set of candidate resources and at least one of the following: a COT resource set, or a first preferred resource set received from a second terminal device; and performing the sidelink transmission on the selected at least one resource, the first set of candidate resources being determined by performing a sensing procedure.

In a third aspect, there is provided a method for communications. The method comprises: in response to a failure of sidelink transmission in any of a set of resources provided by a network device due to a channel access failure for each of the resources, generating, at a terminal device, a negative acknowledge; and transmitting the negative acknowledge to the network device in a Physical Uplink Control Channel (PUCCH) resource subsequent to the set of resources.

In a fourth aspect, there is provided a terminal device. The terminal device comprises a processor and a memory storing instructions. The memory and the instructions are configured, with the processor, to cause the terminal device to perform the method according to the first aspect.

In a fifth aspect, there is provided a terminal device. The terminal device comprises a processor and a memory storing instructions. The memory and the instructions are configured, with the processor, to cause the terminal device to perform the method according to the second aspect.

In a sixth aspect, there is provided a terminal device. The terminal device comprises a processor and a memory storing instructions. The memory and the instructions are configured, with the processor, to cause the terminal device to perform the method according to the third aspect.

In a seventh aspect, there is provided a computer readable medium having instructions stored thereon. The instructions, when executed on at least one processor of a device, cause the device to perform the method according to the first aspect.

In an eighth aspect, there is provided a computer readable medium having instructions stored thereon. The instructions, when executed on at least one processor of a device, cause the device to perform the method according to the second aspect.

In a ninth aspect, there is provided a computer readable medium having instructions stored thereon. The instructions, when executed on at least one processor of a device, cause the device to perform the method according to the third aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which embodiments of the present disclosure can be implemented;

FIG. 2 illustrates an example of automatic gain control (AGC) symbol and guard period (GP) symbol in accordance with some embodiments of the present disclosure;

FIG. 3 illustrates an example of a sub-channel in accordance with some embodiments of the present disclosure;

FIG. 4 illustrates an example of a sensing window and a selection window in a sensing and resource selection procedure;

FIG. 5 illustrates a flowchart of an example method in accordance with some embodiments of the present disclosure;

FIGS. 6 and 7 illustrate an example of a sensing window and a selection window in a sensing and resource selection procedure in accordance with some embodiments of the present disclosure, respectively;

FIG. 8 illustrates a flowchart of an example method in accordance with some other embodiments of the present disclosure;

FIGS. 9A and 9B illustrate an example of selecting a resource for sidelink transmission in accordance with some embodiments of the present disclosure, respectively;

FIG. 10 illustrates a flowchart of an example method in accordance with other embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHZ), FR2 (24.25 GHz to 71 GHZ), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The network device may have the function of network energy saving. Self-Organizing Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

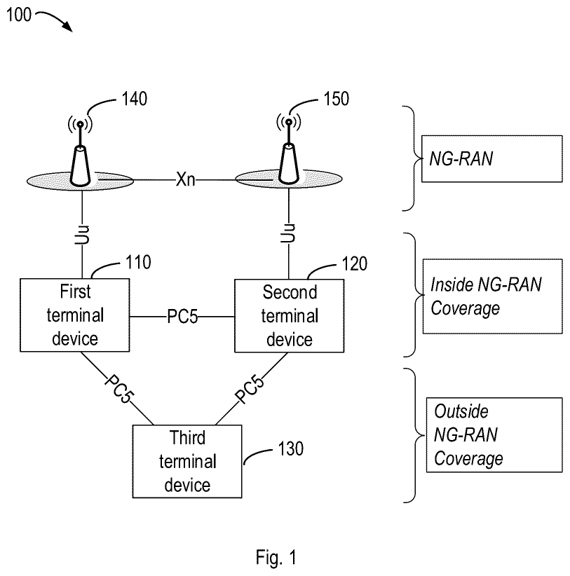

FIG. 1 illustrates a schematic diagram of an example communication network 100 in which embodiments of the present disclosure can be implemented. As shown in FIG. 1, the communication network 100 may include a first terminal device 110, a second terminal device 120, a third terminal device 130, network devices 140 and 150. The network devices 140 and 150 may communicate with the first terminal device 110, the second terminal device 120 and the third terminal device 130 via respective wireless communication channels.

In some embodiments, the network device 140 may be a gNB in NR, and the network device 150 may be an eNB in Long Term Evolution (LTE) system.

It is to be understood that the number of devices in FIG. 1 is given for the purpose of illustration without suggesting any limitations to the present disclosure. The communication network 100 may include any suitable number of network devices and/or terminal devices adapted for implementing embodiments of the present disclosure.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the communications in the communication network 100 may comprise sidelink communication. Sidelink communication is a wireless radio communication directly between two or more terminal devices, such as two or more terminal devices among the first terminal device 110, the second terminal device 120 and the third terminal device 130. In this type of communication, the two or more terminal devices that are geographically proximate to each other can directly communicate without going through the network device 140 or 150 or through a core network. Data transmission in sidelink communication is thus different from typical cellular network communications, in which a terminal device transmits data to the network device 140 or 150 (i.e., uplink transmissions) or receives data from the network device 140 or 150 (i.e., downlink transmissions). In sidelink communication, data is transmitted directly from a source terminal device (such as the first terminal device 110) to a target terminal device (such as the second terminal device 120) through the Unified Air Interface, e.g., PC5 interface, (i.e., sidelink transmissions), as shown in FIG. 1.

Sidelink communication can provide several advantages, including reducing data transmission load on a core network, system resource consumption, transmission power consumption, and network operation costs, saving wireless spectrum resources, and increasing spectrum efficiency of a cellular wireless communication system.

In a sidelink communication system, the sidelink resource is used to transmit information between terminal devices. According to application scenarios, service types, etc., a sidelink communication manner includes but is not limited to device to device (D2D) communication, Vehicle-to-Everything (V2X) communication, etc.

V2X communication enables vehicles to communicate with other vehicles (i.e. Vehicle-to-Vehicle (V2V) communication), with infrastructure (i.e. Vehicle-to-Infrastructure (V2I), with wireless networks (i.e. Vehicle-to-Network (V2N) communication), with pedestrians (i.e. Vehicle-to-Pedestrian (V2P) communication), and even with the owner's home (i.e. Vehicle-to-Home (V2H)). Examples of infrastructure include roadside units such as traffic lights, toll gates and the like. V2X communication can be used in a wide range of scenarios, including in accident prevention and safety, convenience, traffic efficiency and clean driving, and ultimately in relation to autonomous or self-driving vehicles.

For sidelink communications, a terminal device uses resources in sidelink resource pools to transmit or receive signals. The sidelink resource pools include resources in time domain and frequency domain, which are dedicated resources of the sidelink communication, or shared by the sidelink communication and a cellular link.

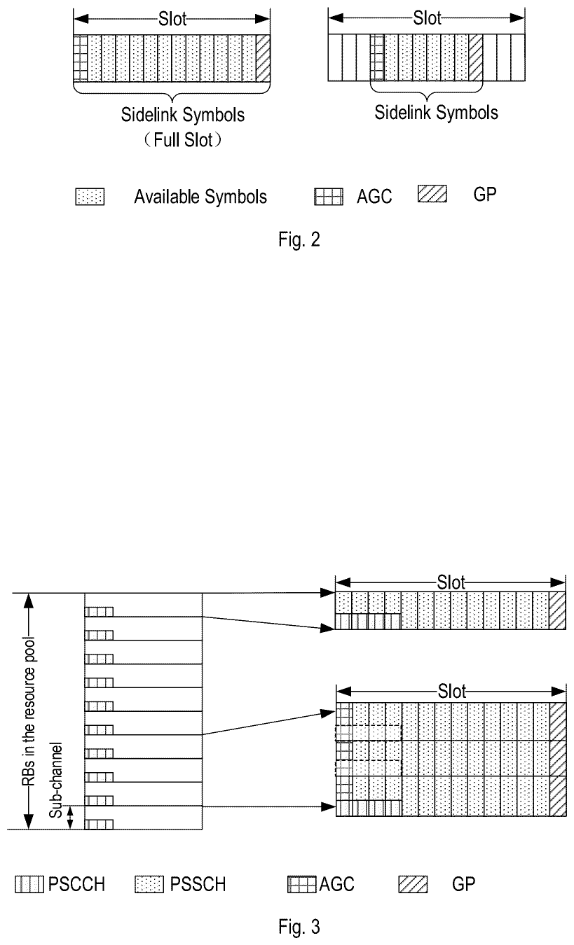

In a sidelink resource pool which may contain multiple slots and resource blocks (RBs), and all or part of the symbols in a slot can be used for sidelink transmission. Within a resource pool, among all the symbols configured for sidelink in each slot, the first symbol (i.e., the start symbol) is used as the automatic gain control (AGC) symbol, and the last symbol used as a guard period (GP) symbol. AGC symbols and GP symbols can be considered as fixed overheads in sidelink resource. In the description of the following embodiments, AGC symbols and GP symbols are included in the sidelink symbols which are indicated by the sidelink channel resource configuration, and AGC symbols carry redundancy sidelink information while GP symbols are not used for carrying sidelink information, as shown in FIG. 2.

The first terminal device 110, the second terminal device 120 and the third terminal device 130 may use sidelink channels to transmit sidelink signaling or information. The sidelink channels include at least one of the following: a Physical Sidelink Control Channel (PSCCH) resource which is used for carrying sidelink control information (SCI), a Physical Sidelink Shared Channel (PSSCH) resource which is used for carrying sidelink data service information, a physical sidelink feedback channel (PSFCH) resource which is used for carrying sidelink Hybrid Automatic Repeat Request (HARQ) feedback information, a physical sidelink broadcast channel (PSBCH) resource which is used for carrying sidelink broadcast information, and a physical sidelink discovery channel (PSDCH) resource which is used for carrying a sidelink discovery signal. Hereinafter, a PSFCH resource is also referred to as a feedback channel resource or HARQ feedback opportunity.

Within a resource pool, a PSSCH resource includes all the symbols in a slot that are configured as sidelink available symbols, and one or more sub-channels in frequency domain, where each sub-channel contains an integer number of consecutive RBs. The number m of RBs included in one sub-channel is also called the sub-channel size. Each slot contained in the resource pool contains multiple available sidelink symbols, and the PSSCH resource is located in the time domain from the first available sidelink symbol in this slot to all available symbols. In the frequency domain, the resource pool contains multiple RBs, according to the sub-channel size m, starting from the first RB in the resource pool, each m RBs are divided into one sub-channel, and each PSSCH channel resource is located on one or more sub-channels. When one of the first terminal device 110, the second terminal device 120 and the third terminal device 130 uses the PSSCH resource to send sidelink information, it can use one or more sub-channels to carry corresponding data information. A PSCCH resource includes t symbols in time domain, and/RBs in frequency domain. Each PSCCH channel resource is located at consecutive t symbols starting from the first symbol in the available symbols in the time domain, and located at the position of consecutive/RBs starting from the first RB in the corresponding sub-channel in the frequency domain, as shown in FIG. 3.

A terminal device may select resources from its transmission resource pool for sidelink signal transmission by performing a sensing and resource selection procedure. Hereinafter, the terminal device performing a sensing and resource selection procedure is also referred to a sensing terminal device.

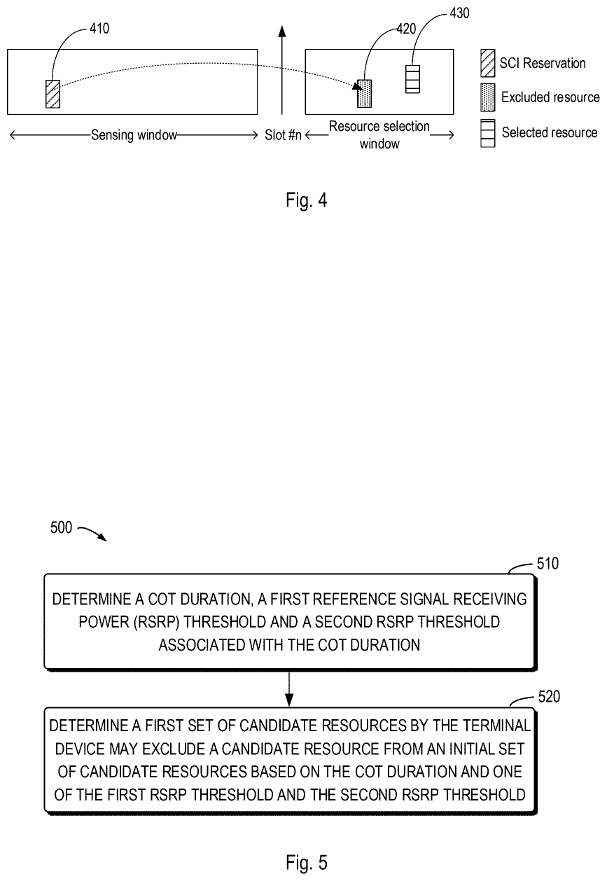

FIG. 4 illustrates an example of a sensing window and a selection window in a sensing and resource selection procedure. As shown, a sensing and resource selection procedure is triggered in slot #n. During the procedure, the sensing terminal device senses resources within a sensing window in a resource pool and try to decode SCI 410 received from a further terminal device. The SCI 410 may comprise control information indicating a resource reserved by the further terminal device. Hereinafter, the terminal device reserving a resource is also referred to a reserving terminal device.

Then, based on the measurement results and control information obtained from the SCI 410, the sensing terminal device may exclude a candidate resource 420 from an initial set of candidate resources within a resource selection window. Thus, the sensing terminal device may determine the remaining candidate resource set within the resource selection window as an available candidate resource set and report the set to a high layer of the sensing terminal device.

Upon receiving the candidate resource set, the high layer of the sensing terminal device may select at least one resource from the candidate resource set for sidelink transmission. For example, the high layer of the sensing terminal device may select a resource 430 from the candidate resource set.

In SL-U, sidelink mode 2 needs to firstly avoid collision between SL terminal devices, and SL terminal devices need to contend resources with terminal devices using other radio access technologies (RATs). For example, the resource 420 excluded by the sensing terminal device may be wasted due to a failure of a Listen Before Talk (LBT) procedure performed by the reserving terminal device for the resource 420. On the other hand, the resource 430 selected by the sensing terminal device may also face LBT failure issue. Hereinafter, terms “LBT” and “channel access” may be used interchangeably.

Embodiments of the present disclosure provide a solution for sidelink transmission so as to solve the above problems and one or more of other potential problems. According to the solution, a Channel Occupancy Time (COT) duration is considered and two different initial Reference Signal Receiving Power (RSRP) thresholds are used in a sensing and resource selection procedure. In this way, more COT resources could be included in a candidate resource set for resource selection. In addition, the sensing terminal device may have more sidelink transmission opportunity. Hereinafter, principle of the present disclosure will be described with reference to FIGS. 5 to 11.

FIG. 5 illustrates a flowchart of an example method in accordance with some embodiments of the present disclosure. In some embodiments, the method 500 can be implemented at a terminal device, such as one of the first terminal device 110, the second terminal device 120 and the third terminal device 130 as shown in FIG. 1. For the purpose of discussion, the method 500 will be described with reference to FIG. 1 as performed by the first terminal device 110 without loss of generality.

At block 510, the first terminal device 110 determines a COT duration, a first RSRP threshold and a second RSRP threshold associated with the COT duration.

At block 520, the first terminal device 110 determines a first set of candidate resources by excluding a candidate resource from an initial set of candidate resources based on the COT duration and one of the first RSRP threshold and the second RSRP threshold.

With the method 500, more COT resources could be included in a candidate resource set for resource selection. In addition, the first terminal device 110 may have more sidelink transmission opportunity.

In some embodiments, the COT duration comprises a first COT duration obtained by the first terminal device 110. For example, the first terminal device 110 may obtain the first COT duration by successfully performing an LBT procedure. Alternatively, the first COT duration may be a COT duration shared by the second terminal device 120.

In such embodiments, the first terminal device 110 may determine whether the candidate resource overlapping with a reserved resource is inside or outside the first COT duration.

If the candidate resource overlapping with the reserved resource is inside the first COT duration, the first terminal device 110 may compare an RSRP measurement on the reserved resource with the first RSRP threshold. The reserved resource is reserved by the second terminal device 120. The first RSRP threshold is greater than a reference RSRP threshold. In turn, the first terminal device 110 may exclude the candidate resource based on the comparing.

On the other hand, if the candidate resource overlapping with the reserved resource is outside the first COT duration, the first terminal device 110 may compare an RSRP measurement on the reserved resource with the second RSRP threshold. The reserved resource is reserved by the second terminal device 120. The second RSRP threshold is equal to or less than a reference RSRP threshold. In turn, the first terminal device 110 may exclude the candidate resource based on the comparing.

In some embodiments, the reference RSRP threshold may be the one defined in TS 38.214. According to TS 38.214, Th(prio_{RX}, prio_{TX}) which is determined as corresponding value of RSRP threshold indicated by the i-th field in sl-Thres-RSRP-List, where i=prio_{RX}+(prio_{TX}−1) * 8. where prio_{RX} is the value of the priority field in a received SCI and prio_{TX} is the priority of the transmission of the UE selecting resources.

In some embodiments, the first RSRP threshold may be determined as B+X dB where B represents the reference RSRP threshold and X is configured by a higher layer of the first terminal device 110. Preferably, X=3 dB. Alternatively or additionally, X is configured by the higher layer per Channel Busy Ratio (CBR) of a resource pool or per priority.

In some embodiments, the first RSRP threshold may be determined by another set of threshold list sl-Thres-RSRP-List-cot, where each entry of the list has a gap (e.g., 3 dB) larger than the sl-Thres-RSRP-List defined in TS 38.214. According to TS 38.214, Th(prio_{RX}, prio_{TX}) which is determined as corresponding value of RSRP threshold indicated by the i-th field in sl-Thres-RSRP-List-cot, where i=prio_{RX}+(prio_{TX}−1) * 8.

In some embodiments, the first RSRP threshold may be a positive infinite value, i.e., the candidate resource will not be excluded.

In some embodiments, the second RSRP threshold may be X dB less than the reference RSRP threshold. For example, the second RSRP threshold may be determined as B−X dB where B represents the reference RSRP threshold and X is configured by a higher layer of the first terminal device 110. Preferably, X=3 dB.

In some embodiments, the second RSRP threshold may be a negative infinite value, i.e., the candidate resource will always be excluded.

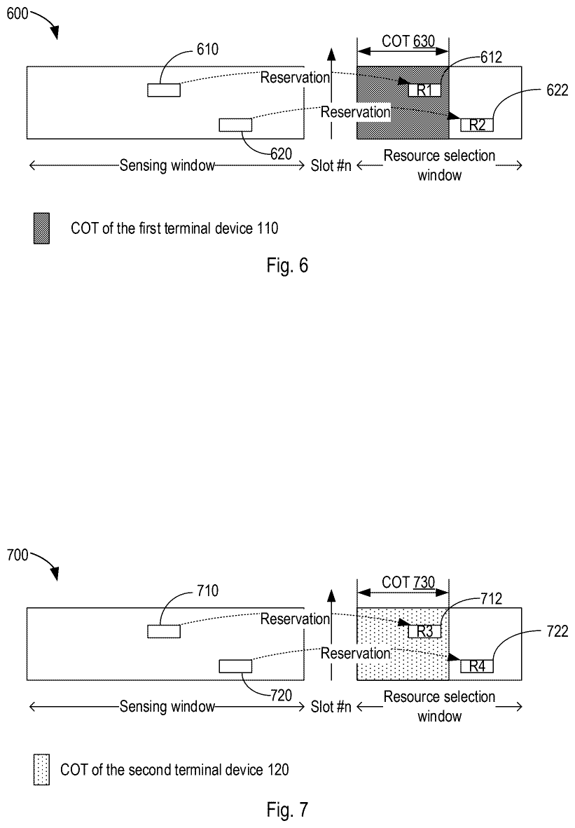

FIG. 6 illustrates an example 600 of a sensing window and a selection window in a sensing and resource selection procedure in accordance with some embodiments of the present disclosure. As shown in FIG. 6, a sensing and resource selection procedure is triggered in slot #n. During the procedure, the first terminal device 110 senses resources within a sensing window in a resource pool and try to decode SCI 610 and 620 received from the second terminal device 120. The SCI 610 may comprise control information indicating a resource R1 reserved by the second terminal device 120. Similarly, The SCI 620 may comprise control information indicating a resource R2 reserved by the second terminal device 120.

A candidate resource 612 in an initial set of candidate resources in the resource selection window overlaps with the reserved resource R2. The candidate resource 612 is inside a first COT duration 630 of the first terminal device 110. In other words, the candidate resource 612 is inside the first COT duration 630 of a sensing terminal device. Thus, the first terminal device 110 compares an RSRP measurement on the reserved resource R1 with the first RSRP threshold. The first RSRP threshold is greater than the reference RSRP threshold. If the RSRP measurement on the reserved resource R1 exceeds the first RSRP threshold, the first terminal device 110 may exclude the candidate resource 612 from the initial set of candidate resources.

A candidate resource 622 in the initial set of candidate resources in the resource selection window overlaps with the reserved resource R2. Because the candidate resource 622 is outside the first COT duration 630, the first terminal device 110 compare an RSRP measurement on the reserved resource R2 with the second RSRP threshold. The second RSRP threshold is equal to or less than the reference RSRP threshold. If the RSRP measurement on the reserved resource R2 exceeds the second RSRP threshold, the first terminal device 110 may exclude the candidate resource 622 from the initial set of candidate resources.

In some embodiments, the COT duration comprises a second COT duration obtained by the second terminal device 120. For example, the second terminal device 120 may obtain the second COT duration by successfully performing an LBT procedure. Alternatively, the second COT duration may be a COT duration shared by the third terminal device 130.

In such embodiments, the first terminal device 110 may determine whether a reserved resource overlapping with the candidate resource is inside or outside the second COT duration.

If a reserved resource overlapping with the candidate resource is inside the second COT duration, the first terminal device 110 may compare an RSRP measurement on the reserved resource with the second RSRP threshold. The reserved resource is reserved by the second terminal device 120. The second RSRP threshold is equal to or less than a reference RSRP threshold. In turn, the first terminal device 110 may exclude the candidate resource based on the comparing.

On the other hand, if a reserved resource overlapping with the candidate resource is outside the second COT duration, the first terminal device 110 may compare an RSRP measurement on the reserved resource with the first RSRP threshold. The reserved resource is reserved by the second terminal device 110. The first RSRP threshold is greater than a reference RSRP threshold. In turn, the first terminal device 110 may exclude the candidate resource based on the comparing.

FIG. 7 illustrates an example 700 of a sensing window and a selection window in a sensing and resource selection procedure in accordance with some embodiments of the present disclosure. As shown in FIG. 7, a sensing and resource selection procedure is triggered in slot #n. During the procedure, the first terminal device 110 senses resources within a sensing window in a resource pool and try to decode SCI 710 and 720 received from the second terminal device 120. The SCI 710 may comprise control information indicating a resource R3 reserved by the second terminal device 120. Similarly, The SCI 720 may comprise control information indicating a resource R4 reserved by the second terminal device 120.

A candidate resource 712 in an initial set of candidate resources in the resource selection window overlaps with the reserved resource R4. The reserved resource R3 is inside the second COT duration 730 of the second terminal device 120. In other words, the reserved resource R3 is inside the second COT duration 730 of a reserving terminal device. Thus, the first terminal device 110 compares an RSRP measurement on the reserved resource R3 with the second RSRP threshold. The second RSRP threshold is equal to or less than the reference RSRP threshold. If the RSRP measurement on the reserved resource R3 exceeds the second RSRP threshold, the first terminal device 110 may exclude the candidate resource 712 from the initial set of candidate resources.

A candidate resource 722 in the initial set of candidate resources in the resource selection window overlaps with the reserved resource R4. Because the reserved resource R4 is outside the second COT duration 730, the first terminal device 110 compare an RSRP measurement on the reserved resource R4 with the first RSRP threshold. The first RSRP threshold is greater than the reference RSRP threshold. If the RSRP measurement on the reserved resource R4 exceeds the first RSRP threshold, the first terminal device 110 may exclude the candidate resource 722 from the initial set of candidate resources.

In some embodiments, the first terminal device 110 may determine a ratio of the number of remaining candidate resources in a first COT duration to a total number of candidate resources in the first COT duration. The first COT duration is obtained by the first terminal device 110. If the ratio is less than a third ratio threshold, the first terminal device 110 may increase at least one of the first RSRP threshold and the second RSRP threshold. For example, the first terminal device 110 may increase at least one of the first RSRP threshold and the second RSRP threshold by +3 dB. In this way, the number of remaining candidate resources in the first COT duration may be ensured.

It shall be understood that the first terminal device 110 may determine the remaining candidate resources after excluding the candidate resource as mentioned above.

In some embodiments, upon determining the first set of candidate resources, the first terminal device 110 may report the set to a high layer of the first terminal device 110. Upon receiving the first set of candidate resources, the high layer of the first terminal device 110 may select at least one resource from the first set of candidate resources for sidelink transmission.

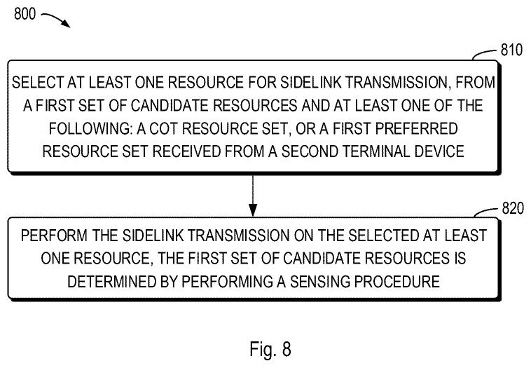

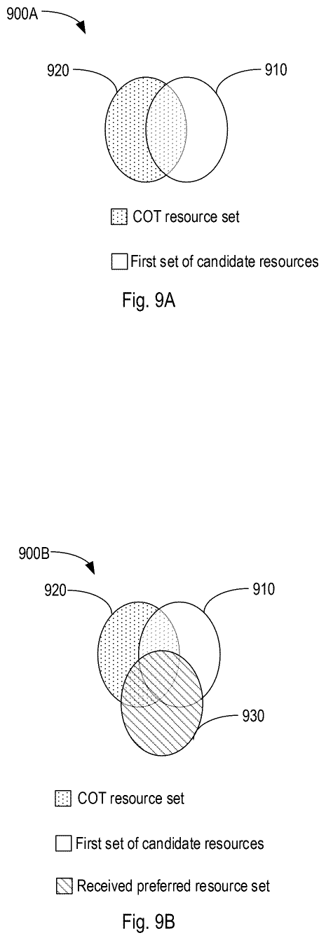

Hereinafter, an example method for selecting at least one resource from the first set of candidate resources will be described with reference to FIGS. 8, 9A and 9B.

FIG. 8 illustrates a flowchart of an example method in accordance with some embodiments of the present disclosure. In some embodiments, the method 800 can be implemented at a terminal device, such as one of the first terminal device 110, the second terminal device 120 and the third terminal device 130 as shown in FIG. 1. For the purpose of discussion, the method 800 will be described with reference to FIG. 1 as performed by the first terminal device 110 without loss of generality.

At block 810, the first terminal device 110 selects at least one resource for sidelink transmission from a first set of candidate resources and at least one of the following:
a COT resource set, or.
a first preferred resource set received from the second terminal device 120.

At block 820, the first terminal device 110 performs the sidelink transmission on the selected at least one resource. The first set of candidate resources is determined by performing a sensing procedure. Hereinafter, the first set of candidate resources which is determined by performing a sensing procedure is also referred to as a sensing result.

With the method 800, more COT resources may be selected for sidelink transmission. In addition, the first terminal device 110 may have more sidelink transmission opportunity.

In some embodiments, the first terminal device 110 may determine the first set of candidate resources by performing at least one of the processes as described with reference to FIGS. 5 to 7. Alternatively, the first terminal device 110 may determine the first set of candidate resources by performing a legacy sensing and resource selection procedure. For example, the first terminal device 110 may determine the first set of candidate resources by performing the process as described with reference to FIG. 4.

In some embodiments, the first terminal device 110 may select a first number of resources from an intersection of the COT resource set and the first set of candidate resources.

In some embodiments, if the first number is less than a second number of resources required for the sidelink transmission, the first terminal device 110 may select a third number of resources which are outside intersection and inside the first set of candidate resources. The third number is equal to a difference between the second number and the first number.

FIG. 9A illustrates an example 900A of selecting a resource for sidelink transmission in accordance with some embodiments of the present disclosure. In the example 900A, within the first set of candidate resources 910 which is determined by performing a sensing procedure, the first terminal device 110 needs to treat a resource which is also inside a COT resource set 920 with higher priority.

When the first terminal device 110 determines the COT resource set 920 via its LBT procedure and sharing COT from other terminal device, the first terminal device 110 may select resources using the first set of candidate resources 910 and the COT resource set 920.

For example, the first terminal device 110 may firstly select resources for transmissions within an intersection of the first set of candidate resources 910 and the COT resource set 920 until it becomes impossible to select a resource within the intersection under the constraint defined in Release 16.

After this, if the number of selected resources is smaller than the required number of transmissions for a transmission block (TB), the first terminal device 110 may select resources for the remaining transmissions outside the intersection but inside the first set of candidate resources 910 under the constraint defined in Rel-16.

In some embodiments, the implementation of the example 900 may be enabled or disabled by a radio resource control (RRC) parameter.

In some embodiments, Table 1 shows a change in TS 38.321 associated with the example 900A in Release16.

```
TABLE 1
  first set initial transmission
  3> if configured by RRC enabling select COT resource with higher priority and when
the UE doesn't have own sensing result as specified in clause 8.1.4 of TS 38.214 [7] and
information of a set of COT resource is obtained:
  4> randomly select the time and frequency resources for one transmission opportunity
from the resources belonging to the COT resource set according to the amount of selected
frequency resources and the remaining PDB of SL data available in the logical channel(s)
allowed on the carrier.
  3> if configured by RRC enabling select COT resource with higher priority and when
the UE has own sensing result as specified in clause 8.1.4 of TS 38.214 [7] and information
of a set of COT resource is obtained:
  4> randomly select the time and frequency resources for one transmission opportunity
within the intersection of the COT resource set and the resources indicated by the physical
layer as specified in clause 8.1.4 of TS 38.214 [7] according to the amount of selected
frequency resources and the remaining PDB of SL data available in the logical channel(s)
allowed on the carrier.
  5> if there are no resources within the intersection that can be selected as the time and
frequency resources for the one transmission opportunity according to the amount of
selected frequency resources and the remaining PDB of SL data available in the logical
channel(s) allowed on the carrier.
  6> randomly select the time and frequency resources for one transmission opportunity
from the resources indicated by the physical layer as specified in clause 8.1.4 of TS 38.214
[7], according to the amount of selected frequency resources and the remaining PDB of SL
data available in the logical channel(s) allowed on the carrier.
  set of retransmissions:
  4> if configured by RRC enabling select COT resource with higher priority and when
the UE has own sensing result as specified in clause 8.1.4 of TS 38.214 [7] and information
of a set of COT resource is obtained:
  5> if there are available resources left in the intersection of the COT resource set and
the resources indicated by the physical layer as specified in clause 8.1.4 of TS 38.214 [7]
for more transmission opportunities:
  6> randomly select the time and frequency resources for one or more transmission
opportunities from the available resources within the intersection according to the amount
of selected frequency resources, the selected number of HARQ retransmissions and the
remaining PDB of SL data available in the logical channel(s) allowed on the carrier by
ensuring the minimum time gap between any two selected resources in case that PSFCH is
configured for this pool of resources and that a retransmission resource can be indicated by
the time resource assignment of a prior SCI according to clause 8.3.1.1 of TS 38.212 [9].
  6> if the number of time and frequency resources that has been maximally selected for
one or more transmission opportunities from the available resources within the intersection
is smaller than the selected number of HARQ retransmissions:
  7> randomly select the time and frequency resources for the remaining transmission
opportunities except for the selected resources within the intersection from the available
resources outside the intersection but left in the resources indicated by the physical layer
according to clause 8.1.4 of TS 38.214 [7], according to the amount of selected frequency
resources, the selected number of HARQ retransmissions and the remaining PDB of SL
data available in the logical channel(s) allowed on the carrier by ensuring the minimum
time gap between any two selected resources in case that PSFCH is configured for this pool
of resources and that a retransmission resource can be indicated by the time resource
assignment of a prior SCI according to clause 8.3.1.1 of TS 38.212 [9].
  4> if configured by RRC enabling select COT resource with higher priority and when
the UE hasn't own sensing result as specified in clause 8.1.4 of TS 38.214 [7] and
information of a set of COT resource is obtained:
  5> if there are available resources left in the COT resource set for more transmission
opportunities:
  6> randomly select the time and frequency resources for one or more transmission
opportunities from the available resources belonging to the COT resource set according to
the amount of selected frequency resources, the selected number of HARQ retransmissions
and the remaining PDB of SL data available in the logical channel(s) allowed on the carrier
by ensuring the minimum time gap between any two selected resources in case that PSFCH
is configured for this pool of resources and that a retransmission resource can be indicated
by the time resource assignment of a prior SCI according to clause 8.3.1.1 of TS 38.212 [9];
  4> use the randomly selected resource to select a set of periodic resources spaced by
the resource reservation interval for transmissions of PSCCH and PSSCH corresponding to
the number of retransmission opportunities of the MAC PDUs determined in TS 38.214 [7];
  4> consider the first set of transmission opportunities as the initial transmission
opportunities and the other set(s) of transmission opportunities as the retransmission
opportunities;
4> consider the sets of initial transmission opportunities and retransmission opportunities
as the selected sidelink grant.
```

In some embodiments, the first terminal device 110 may select a first number of resources from a first intersection of the COT resource set, the first set of candidate resources and the first preferred resource set.

In some embodiments, if the first number is less than a second number of resources required for the sidelink transmission, the first terminal device 110 may select a third number of resources which are outside the first intersection and inside a second intersection of the first set of candidate resources and the first preferred resource set.

In some embodiments, if a sum of the first number and the third number is less than the second number, the first terminal device 110 may select a fourth number of resources which are outside the first and second intersections and inside the first set of candidate resources. The fourth number is equal to a difference between the second number and the sum.

FIG. 9B illustrates an example 900B of selecting a resource for sidelink transmission in accordance with some embodiments of the present disclosure. In the example 900B, within the first set of candidate resources 910 and the received preferred resource set 930, the first terminal device 110 needs to treat resources also inside COT resource set 920 with higher priority.

When the first terminal device 110 determines the COT resource set 920 via its LBT procedure and sharing COT from other terminal device, the first terminal device 110 mya select resources using the first set of candidate resources 910, the received preferred resource set 930 and the set of COT resource

For example, the first terminal device 110 may firstly select resources for transmissions within an intersection M of the first set of candidate resources 910, the received preferred resource set 930 and the COT resource set 920 until it becomes impossible to select a resource within the intersection under the constraint defined in Release 16.

After this, if the number of selected resources is smaller than the required number of transmissions for a TB, the first terminal device 110 may select resources for the remaining transmissions outside the intersection M but inside intersection N of the first set of candidate resources 910 and the received preferred resource set 930 under the constraint defined in Release 16.

After this, if the number of selected resources is smaller than the required number of transmissions for a TB, the first terminal device 110 may select resources for the remaining transmissions outside the intersections M and N but inside the first set of candidate resources 910 under the constraint defined in Release 16.

In some embodiments, Table 2 shows a change in TS 38.321 associated with the example 900B in Release 16.

```
TABLE 2
For initial transmission
  3> if configured by RRC, interUECoordinationScheme1Explicit or
interUECoordinationScheme1Condition enabling reception of preferred resource set and
non-preferred resource set and when the UE doesn't have own sensing result as specified in
clause 8.1.4 of TS 38.214 [7] and if a preferred resource set is received from a UE and
information of a set of COT resource is obtained:
  4> randomly select the time and frequency resources for one transmission opportunity
within the intersection of the COT resource and the resources belonging to the received
preferred resource set for a MAC PDU to be transmitted to the UE providing the preferred
resource set, according to the amount of selected frequency resources and the remaining
PDB of SL data available in the logical channel(s) allowed on the carrier.
  5> if there are no resources within the intersection that can be selected as the time and
frequency resources for the one transmission opportunity according to the amount of
selected frequency resources and the remaining PDB of SL data available in the logical
channel(s) allowed on the carrier.
  6> randomly select the time and frequency resources for one transmission opportunity
from the resources belonging to the received preferred resource set, according to the
amount of selected frequency resources and the remaining PDB of SL data available in the
logical channel(s) allowed on the carrier.
  3> if configured by RRC, interUECoordinationScheme1Explicit or
interUECoordinationScheme1Condition enabling reception of preferred resource set and
non-preferred resource set and when the UE has own sensing result as specified in clause
8.1.4 of TS 38.214 [7] and if a preferred resource set is received from a UE and
information of a set of COT resource is obtained:
  4> randomly select the time and frequency resources for one transmission opportunity
within the intersection of the COT resource and the received preferred resource set and the
resources indicated by the physical layer as specified in clause 8.1.4 of TS 38.214 [7] for a
MAC PDU to be transmitted to the UE providing the preferred resource set, according to
the amount of selected frequency resources and the remaining PDB of SL data available in
the logical channel(s) allowed on the carrier.
  5> if there are no resources within the intersection that can be selected as the time and
frequency resources for the one transmission opportunity according to the amount of
selected frequency resources and the remaining PDB of SL data available in the logical
channel(s) allowed on the carrier.
  6>randomly select the time and frequency resources for one transmission opportunity
within the intersection of the received preferred resource set and the resources indicated by
the physical layer as specified in clause 8.1.4 of TS 38.214 [7] for a MAC PDU to be
transmitted to the UE providing the preferred resource set, according to the amount of
selected frequency resources and the remaining PDB of SL data available in the logical
channel(s) allowed on the carrier.
    7> if there are no resources within the intersection that can be selected as the
time and frequency resources for the one transmission opportunity according to the amount
of selected frequency resources and the remaining PDB of SL data available in the logical
channel(s) allowed on the carrier.
      8> randomly select the time and frequency resources for one
transmission opportunity from the resources indicated by the physical layer as specified in
clause 8.1.4 of TS 38.214 [7], according to the amount of selected frequency resources and
the remaining PDB of SL data available in the logical channel(s) allowed on the carrier.
For one or more HARQ retransmission
  4> if configured by RRC, interUECoordinationScheme1Explicit or
interUECoordinationScheme1Condition enabling reception of preferred resource set and
non-preferred resource set and when the UE has own sensing result as specified in clause
8.1.4 of TS 38.214 [7] and if a preferred resource set is received from a UE and information
of a set of COT resource is obtained:
  5> if there are available resources left in the intersection M of the set of COT resource
and the received preferred resource set and the resources indicated by the physical layer as
specified in clause 8.1.4 of TS 38.214 [7] for more transmission opportunities:
  6> randomly select the time and frequency resources for one or more transmission
opportunities from the available resources within the intersection M for a MAC PDU to be
transmitted to the UE providing the preferred resource set, according to the amount of
selected frequency resources, the selected number of HARQ retransmissions and the
remaining PDB of SL data available in the logical channel(s) allowed on the carrier by
ensuring the minimum time gap between any two selected resources in case that PSFCH is
configured for this pool of resources and that a retransmission resource can be indicated by
the time resource assignment of a prior SCI according to clause 8.3.1.1 of TS 38.212 [9].
  6> if the number of time and frequency resources that has been maximally selected for
one or more transmission opportunities from the available resources within the intersection
M is smaller than the selected number of HARQ retransmissions:
  7>randomly select the time and frequency resources for one or more transmission
opportunities from the available resources within the intersection N of the received
preferred resource set and the resources indicated by the physical layer as specified in
clause 8.1.4 of TS 38.214 [7] for a MAC PDU to be transmitted to the UE providing the
preferred resource set, according to the amount of selected frequency resources, the
selected number of HARQ retransmissions and the remaining PDB of SL data available in
the logical channel(s) allowed on the carrier by ensuring the minimum time gap between
any two selected resources in case that PSFCH is configured for this pool of resources and
that a retransmission resource can be indicated by the time resource assignment of a prior
SCI according to clause 8.3.1.1 of TS 38.212 [9].
  7> if the number of time and frequency resources that has been maximally selected for
one or more transmission opportunities from the available resources within the intersection
N is smaller than the selected number of HARQ retransmissions:
7> randomly select the time and frequency resources for the remaining transmission
opportunities except for the selected resources within the intersection N from the available
resources outside the intersection N but left in the resources indicated by the physical layer
according to clause 8.1.4 of TS 38.214 [7], according to the amount of selected frequency
resources, the selected number of HARQ retransmissions and the remaining PDB of SL
data available in the logical channel(s) allowed on the carrier by ensuring the minimum
time gap between any two selected resources in case that PSFCH is configured for this pool
of resources and that a retransmission resource can be indicated by the time resource
assignment of a prior SCI according to clause 8.3.1.1 of TS 38.212 [9].
```

In some embodiments, the first terminal device 110 may update the first preferred resource set by incorporating the COT resource set into the first preferred resource set. In other words, the first terminal device 110 may consider the COT resource set as a kind of preferred resource set. In such embodiments, an example of a change in TS 38.214 may be as shown in Table 3.

```
TABLE 3
8.1.5A UE procedure for determining slots and resource blocks indicated
by a preferred or non-preferred resource set
  The set of slots and resource blocks within a sharing COT from other
  UEs are regarded as preferred resource set
```

In some embodiments, the COT resource set comprises at least one of the following:
sharing COT resources received from the third terminal device 130, or
COT resources obtained by performing an LBT procedure.

In such embodiments, an example of a change in TS 38.214 may be as shown in Table 4.

```
TABLE 4
8.1.5A UE procedure for determining slots and resource blocks indicated
by a preferred or non-preferred resource set
  The set of slots and resource blocks within a COT obtained by
  UE's LBT success is regarded as preferred resource set
```

In some embodiments, the first terminal device 110 may determine the COT resource set as a second preferred resource set. In turn, the first terminal device 110 may transmit, to a fourth terminal device, information about the second preferred resource set for sidelink transmission of the fourth terminal device.

In such embodiments, an example of a change in TS 38.214 may be as shown in Table 5.

```
TABLE 5
8.1.4A UE procedure for determining a set of preferred or non-preferred
resources for another UE's transmission
      When determining a preferred resource set for another UE's
  transmission, the UE considers any single slot resource(s) satisfying at
  least one of the following conditions as preferred resource(s):
    resource(s) within a COT duration that can be shared to another
    UE, i.e., COT sharing as one of a preferred resource set
```

In some embodiments, the selected at least one resource comprises a first resource and a second resource which are used for transmissions of a single transmission block and outside the COT resource set, and a time gap between the first resource and the second resource is greater than a sum of at least the following:
a first time gap between the first resource and a feedback channel resource associated with the first resource,
a second time gap for performing a listen before talk procedure of type 1 on the second resource, or.
a third time gap for preparing a subsequent transmission on the second resource.

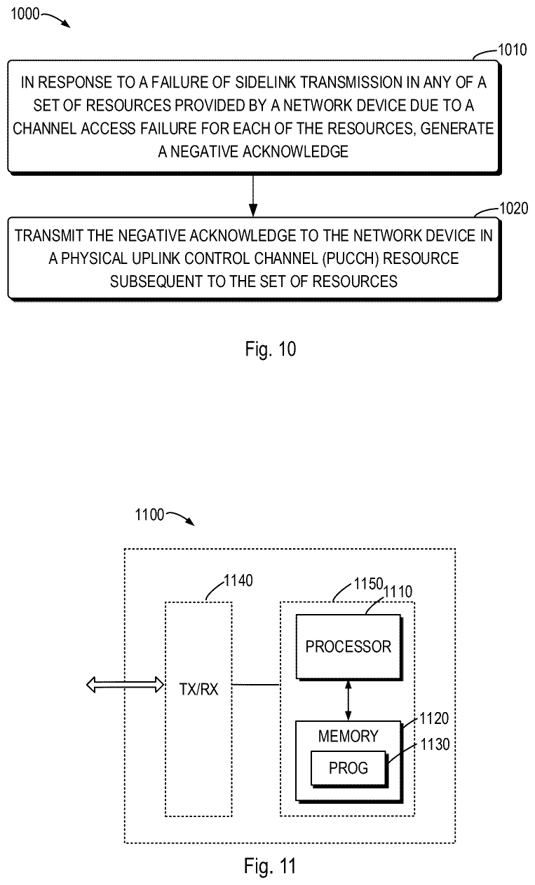

FIG. 10 illustrates a flowchart of an example method 1000 in accordance with other embodiments of the present disclosure. In some embodiments, the method 1000 can be implemented at a terminal device, such as one of the first terminal device 110, the second terminal device 120 and the third terminal device 130 as shown in FIG. 1. For the purpose of discussion, the method 1000 will be described with reference to FIG. 1 as performed by the first terminal device 110 without loss of generality.

At block 1010, in response to a failure of sidelink transmission in any of a set of resources provided by the network device 140 due to a channel access failure for each of the resources, the first terminal device 110 generates a negative acknowledge (NACK).

At block 1020, the first terminal device 110 transmits the NACK to the network device 140 in a Physical Uplink Control Channel (PUCCH) resource subsequent to the set of resources.

In some embodiments, the first terminal device 110 may receive, from the network device 140, first configuration information about the set of resources via downlink control information (DCI) or a configured grant (CG) in a radio resource control (RRC) signalling.

In some embodiments, the first terminal device 110 may receive the first configuration information about the set of resources in a licensed band or unlicensed band.

In some embodiments, the first terminal device 110 may transmit the NACK in a licensed band or unlicensed band.

In some embodiments, the first terminal device 110 may determine a first priority value of transmission of the NACK in the PUCCH resource to be equal to a second priority value of the sidelink transmission that was not transmitted due to the channel access failure

In some embodiments, if the sidelink transmission is absent due to the channel access failure, the first terminal device 110 may keep the number of transmissions of a data packet for the sidelink transmission unchanged. In other words, for SL-U, the number of transmissions of the data packet should not count the failed transmissions caused by the channel access failure. When a transmission of the data packet was not performed due to the channel access failure, the number of transmissions of the data packet should not increased

In some embodiments, the first terminal device 110 may determine a first number of channel access failures associated with the sidelink transmission. If a second number of transmissions of a data packet for the sidelink transmission exceeds a threshold and the first number is greater than zero, the first terminal device 110 may receive, from the network device 140, second configuration information about resources for retransmission of the data packet. In such embodiments, the number of the resources for the retransmission of the data packet is equal to the first number.

For example, the threshold may be equal to sl-MaxTransNum which is configured in sl-CG-MaxTransNumList for the sidelink grant by RRC and a counter may be used to count the channel access failure. When the number of transmissions of the data packet has reached sl-MaxTransNum and the counter is non-zero M, the network device 140 could still provide further M resources for retransmission of the data packet as long as packet delay budget (PDB) requirement is satisfied.

FIG. 11 is a simplified block diagram of a device 1100 that is suitable for implementing some embodiments of the present disclosure. The device 1100 can be considered as a further example embodiment of the first terminal device 110 as shown in FIG. 1. Accordingly, the device 1100 can be implemented at or as at least a part of the terminal device 110.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1120 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2 interface for bidirectional communications between gNBs or eNBs, S1 interface for communication between a Mobility Management Entity (MME)/Serving Gateway (S-GW) and the gNB or eNB, Un interface for communication between the gNB or eNB and a relay node (RN), or Uu interface for communication between the gNB or eNB and a terminal device.

The program 1130 is assumed to include program instructions that, when executed by the associated processor 1110, enable the device 1100 to operate in accordance with the embodiments of the present disclosure, as discussed herein with reference to FIGS. 1 to 12. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 1 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific embodiment details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-10. (canceled)

11. A method performed by a terminal device, comprising:
generating a negative acknowledgment (NACK), when the terminal device does not transmit a physical sidelink shared channel (PSSCH) in any of provided resources due to a failed channel access procedure for operation with shared spectrum channel access; and
reporting the NACK in a physical uplink control channel (PUCCH) resource.

12. The method of claim 11, wherein a first priority value of the NACK is same as a second priority value of the PSSCH that was not transmitted due to the failed channel access procedure.

13. The method of claim 11, wherein the provided resources are provided by a downlink control information (DCI) or a configured grant.

14. A terminal device, comprising a processor configured to:
generate a negative acknowledgment (NACK), when the terminal device does not transmit a physical sidelink shared channel (PSSCH) in any of provided resources due to a failed channel access procedure for operation with shared spectrum channel access; and
report the NACK in a physical uplink control channel (PUCCH) resource.

15. The terminal device of claim 14, wherein a first priority value of the NACK is same as a second priority value of the PSSCH that was not transmitted due to the failed channel access procedure.

16. The terminal device of claim 14, wherein the provided resources are provided by a downlink control information (DCI) or a configured grant.
